(19) United States
(12) Patent Application Publication
(10) Pub. No.: US 2024/0193792 A1
(43) Pub. Date: Jun. 13, 2024

(54) DEVICE AND METHOD FOR CALCULATING SWINGING DIRECTION OF HUMAN FACE IN OBSCURED HUMAN FACE IMAGE

(71) Applicant: Industrial Technology Research Institute, Hsinchu (TW)

(72) Inventors: Jian-Lung Chen, Taoyuan City (TW); Ting-Hsun Cheng, Chiayi County (TW); Yu-Ju Chao, Hsinchu County (TW); Yu-Hsin Lin, Miaoli County (TW)

(73) Assignee: Industrial Technology Research Institute, Hsinchu (TW)

(21) Appl. No.: 18/171,653

(22) Filed: Feb. 20, 2023

(30) Foreign Application Priority Data
Dec. 7, 2022 (TW) 111146885

(51) Int. Cl. G06T 7/246; G06F 3/14; G06T 19/20; G06V 10/74; G06V 40/16

(52) U.S. Cl. CPC G06T 7/246; G06F 3/14; G06T 19/20; G06V 10/761; G06V 40/171; G06T 2207/10024; G06T 2207/10048; G06T 2207/30201; G06T 2219/2016

(57) ABSTRACT

A device and a method for calculating a swinging direction of a human face in an obscured human face image are provided. The method includes the following. An obscured human face image including a human face is captured. Non-obscured face detection technology is used to obtain a feature anchor point to be replaced in the obscured human face image, obscured face detection technology is used to obtain a plurality of candidate feature anchor points in the obscured human face image, and the plurality of candidate feature anchor points are used to determine an updated feature anchor point corresponding to the feature anchor point to be replaced. An adjustment operation is performed on a three-dimensional model to obtain an adjusted three-dimensional model. The updated feature anchor point and the adjusted three-dimensional model are used to calculate a swinging direction of the human face.

### CROSS-REFERENCE TO RELATED APPLICATION

This application claims the priority benefit of Taiwanese application no. 111146885, filed on Dec. 7, 2022. The entirety of the above-mentioned patent application is hereby incorporated by reference herein and made a part of this specification.

### TECHNICAL FIELD

The disclosure relates to a device and a method for calculating a swinging direction of a human face in an obscured human face image.

### BACKGROUND

Currently, non-obscured face detection technology may be used to calculate a swinging direction of a human face. However, when the human face is obscured by a mask, sunglasses, or a hat, non-obscured face detection technology cannot correctly calculate the swinging direction of the human face. On the other hand, although obscured face detection technology may be used to detect an obscured human face, it cannot calculate the swinging direction of the human face.

### SUMMARY

According to an embodiment of the disclosure, a device for calculating a swinging direction of a human face in an obscured human face image includes an image capturing device, a storage medium, and a processor. The storage medium stores a three-dimensional model. The processor is coupled to the image capturing device and the storage medium. The processor is configured to: capture an obscured human face image including a human face through the image capturing device; use non-obscured face detection technology to obtain a feature anchor point to be replaced in the obscured human face image, use obscured face detection technology to obtain a plurality of candidate feature anchor points in the obscured human face image, and use the plurality of candidate feature anchor points to determine an updated feature anchor point corresponding to the feature anchor point to be replaced; perform an adjustment operation on a three-dimensional model to obtain an adjusted three-dimensional model; and use the updated feature anchor point and the adjusted three-dimensional model to calculate a swinging direction of the human face.

According to an embodiment of the disclosure, a method for calculating a swinging direction of a human face in an obscured human face image includes the following. An obscured human face image including a human face is captured. Non-obscured face detection technology is used to obtain a feature anchor point to be replaced in the obscured human face image, obscured face detection technology is used to obtain a plurality of candidate feature anchor points in the obscured human face image, and the plurality of candidate feature anchor points are used to determine an updated feature anchor point corresponding to the feature anchor point to be replaced. An adjustment operation is performed on a three-dimensional model to obtain an adjusted three-dimensional model. The updated feature anchor point and the adjusted three-dimensional model are used to calculate a swinging direction of the human face.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram of a device for calculating a swinging direction of a human face in an obscured human face image according to an embodiment of the disclosure.

FIG. 2 is a flowchart of a method for calculating a swinging direction of a human face in an obscured human face image according to an embodiment of the disclosure.

FIG. 3 is a schematic diagram of using candidate feature anchor points to calculate updated coordinates according to an embodiment of the disclosure.

FIG. 4 is a schematic diagram of weights and distances of candidate feature anchor points according to an embodiment of the disclosure.

FIG. 5 is a schematic diagram of correspondence relationships between feature anchor points to be replaced and updated feature anchor points according to an embodiment of the disclosure.

FIG. 6 is a schematic diagram of point locations in a three-dimensional model according to an embodiment of the disclosure.

FIG. 7 is a schematic diagram of central axis point locations and opposite point locations relative to a central axis of the three-dimensional model of FIG. 6.

FIG. 8 is a schematic diagram of translating an updated feature anchor point to a central position in an obscured human face image according to an embodiment of the disclosure.

FIG. 9 is a schematic diagram of a swinging direction of a human face according to an embodiment of the disclosure.

### DESCRIPTION OF THE EMBODIMENTS

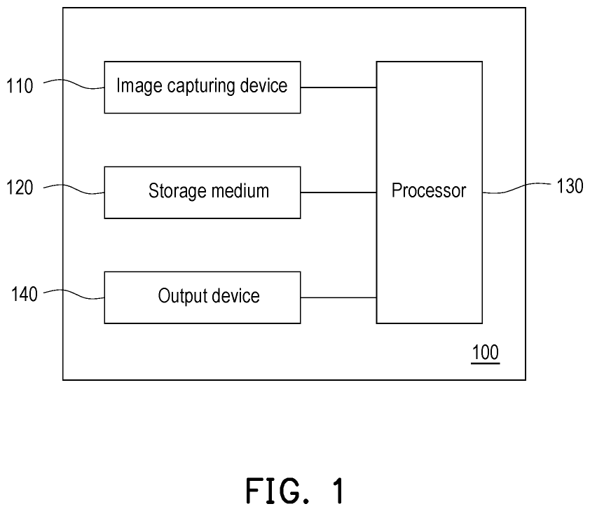

FIG. 1 is a schematic diagram of a device 100 for calculating a swinging direction of a human face in an obscured human face image according to an embodiment of the disclosure. The device 100 may include an image capturing device 110, a storage medium 120, and a processor 130. The processor 130 may be coupled to the image capturing device 110 and the storage medium 120. In other embodiments, the device 100 may also include an output device 140 coupled to the processor 130.

The image capturing device 110 is a camera, a video camera, or other devices suitable for capturing an image, for example.

The storage medium 120 is any type of fixed or removable random access memory (RAM), read-only memory (ROM), flash memory, hard disk drive (HDD), solid state drive (SSD), or a similar element or a combination of elements above, for example, and is configured to store a plurality of modules or various application programs that may be executed by the processor 130. In this embodiment, the storage medium 120 may store a three-dimensional model, which will be further described in subsequent embodiments.

The processor 130 is a central processing unit (CPU), or any other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or any other similar element or a combination of elements above, for example. The processor 130 may access and execute the modules and various application programs stored in the storage medium 120.

The output device 140 is configured to output a swinging direction of a human face calculated by the processor 130. The output device 140 is a display, for example.

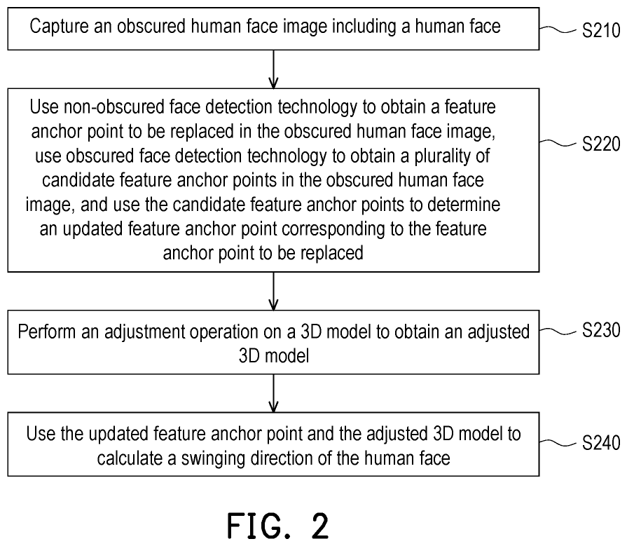

FIG. 2 is a flowchart of a method for calculating a swinging direction of a human face in an obscured human face image according to an embodiment of the disclosure. With reference to FIG. 1 and FIG. 2 together, the method of this embodiment is applicable to the device 100 of FIG. 1. The detailed steps of the method for calculating a swinging direction of a human face in an obscured human face image accompanied with the elements of the device 100 will now be described in the following embodiments of the disclosure.

In step S210, the processor 130 may capture an obscured human face image including a human face through the image capturing device 110. Specifically, in this embodiment, the human face in the obscured human face image is obscured by a mask, sunglasses, or a hat, for example. In an embodiment, the obscured human face image may include a color image or an infrared image.

In step S220, the processor 130 may use non-obscured face detection technology to obtain a feature anchor point to be replaced in the obscured human face image, use obscured face detection technology to obtain a plurality of candidate feature anchor points in the obscured human face image, and use the plurality of candidate feature anchor points to determine an updated feature anchor point corresponding to the feature anchor point to be replaced. The disclosure does not limit the number of feature anchor points to be replaced and/or the number of the plurality of candidate feature anchor points. For convenience of description below, the number of feature anchor points to be replaced being 68 and the number of the plurality of candidate feature anchor points being 468 will be taken as an example.

In an embodiment, each of the plurality of candidate feature anchor points may correspond to a weight, and each of the plurality of candidate feature anchor points may correspond to candidate coordinates. The processor 130 may use the weight and the candidate coordinates to calculate updated coordinates of the updated feature anchor point. For example, according to Formula 1 and Formula 2 below, the processor 130 may use the candidate coordinates and the weights of the 468 candidate feature anchor points to determine X-axis coordinates Xⱼ and Y-axis coordinates Yⱼ of 68 updated feature anchor points respectively corresponding to the 68 feature anchor points to be replaced. As shown in Formula 3, the sum of the weights of the 468 candidate feature anchor points is 1. In other words, the weights of the 468 candidate feature anchor points may be positive, negative, or 0.

Xⱼ=Σᵢ₌₁⁴⁶⁸ Wᵢ×Xᵢ (Formula 1)

Yⱼ=Σᵢ₌₁⁴⁶⁸ Wᵢ×Yᵢ (Formula 2)

Σᵢ₌₁⁴⁶⁸ Wᵢ=1 (Formula 3)

where Wᵢ is the weight of the i-th candidate feature anchor point, Xᵢ is the candidate X-axis coordinate of the i-th candidate feature anchor point, Yᵢ is the candidate Y-axis coordinate of the i-th candidate feature anchor point, the value of i ranges from 1, 2, . . . , to 468, and the value of j ranges from 0, 1, 2, . . . , to 67.

In an embodiment, the processor 130 may obtain M candidate feature anchor points from the plurality of candidate feature anchor points, and a distance between each of the M candidate feature anchor points and the feature anchor point to be replaced is less than a distance threshold. Then, the processor 130 may use the weight and the candidate coordinates of each of the M candidate feature anchor points to calculate the updated coordinates, where M is a non-zero natural number. The description will be continued below.

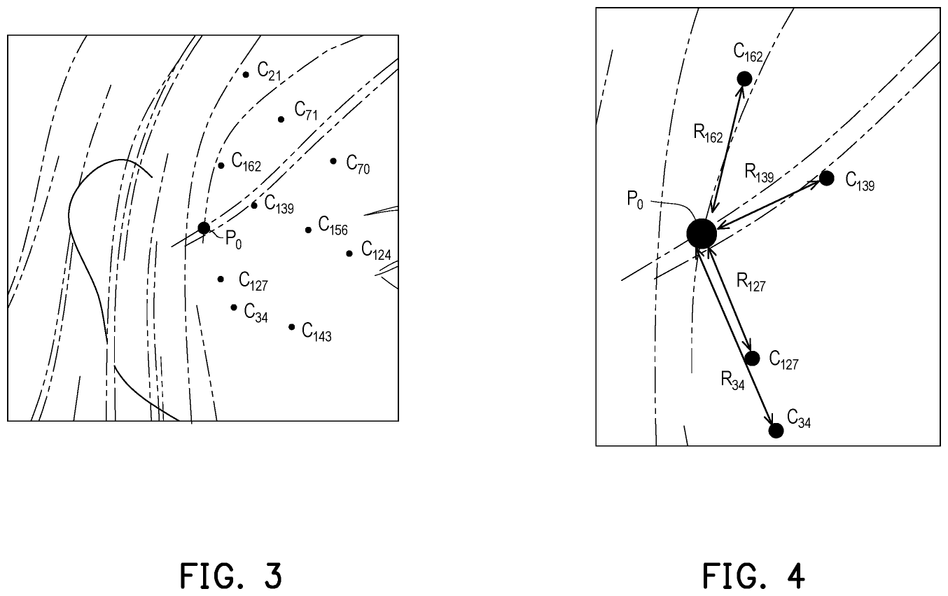

FIG. 3 is a schematic diagram of using candidate feature anchor points to calculate updated coordinates according to an embodiment of the disclosure. With reference to FIG. 1 and FIG. 3 together, when the processor 130 is to determine an updated feature anchor point corresponding to a feature anchor point to be replaced P₀, to calculate updated coordinates of the updated feature anchor point, the processor 130 may select a candidate feature anchor point C₁₂₇, a candidate feature anchor point C₁₃₉, a candidate feature anchor point C₁₆₂, a candidate feature anchor point C₃₄, and a candidate feature anchor point C₁₅₆ at a relatively close distance to the feature anchor point to be replaced P₀ from the 468 candidate feature anchor points (i.e., M is 5 in this embodiment). In other words, since the distance between the feature anchor point to be replaced P₀ and each of a candidate feature anchor point C₂₁, a candidate feature anchor point C₇₁, a candidate feature anchor point C₇₀, a candidate feature anchor point C₁₂₄, and a candidate feature anchor point C₁₄₃ is greater than a predetermined distance threshold, the processor 130 may not consider the weights and the candidate coordinates of the candidate feature anchor point C₂₁, the candidate feature anchor point C₇₁, the candidate feature anchor point C₇₀, the candidate feature anchor point C₁₂₄, and candidate feature anchor point C₁₄₃.

Then, according to Formula 4 and Formula 5 below, the processor 130 may use the weights and the candidate coordinates of the candidate feature anchor point C₁₂₇, the candidate feature anchor point C₁₃₉, the candidate feature anchor point C₁₆₂, the candidate feature anchor point C₃₄, and the candidate feature anchor point C₁₅₆ to calculate the updated coordinates of the updated feature anchor point. Specifically, the updated coordinates may include an updated X-axis coordinate UX₀ and an updated Y-axis coordinate UY₀.

UX₀=W₁₂₇×X₁₂₇+W₁₃₉×X₁₃₉+W₁₆₂×X₁₆₂+W₃₄×X₃₄+W₁₅₆×X₁₅₆ (Formula 4)

UY₀=W₁₂₇×Y₁₂₇+W₁₃₉×Y₁₃₉+W₁₆₂×Y₁₆₂+W₃₄×Y₃₄+W₁₅₆×Y₁₅₆ (Formula 5)

where X₁₂₇ is the candidate X-axis coordinate of the candidate feature anchor point C₁₂₇, X₁₃₉ is the candidate X-axis coordinate of the candidate feature anchor point C₁₃₉, X₁₆₂ is the candidate X-axis coordinate of the candidate feature anchor point C₁₆₂, X₃₄ is the candidate X-axis coordinate of the candidate feature anchor point C₃₄, and X₁₅₆ is the candidate X-axis coordinate of the candidate feature anchor point C₁₅₆; Y₁₂₇ is the candidate Y-axis coordinate of the candidate feature anchor point C₁₂₇, Y₁₃₉ is the candidate Y-axis coordinate of the candidate feature anchor point C₁₃₉, Y₁₆₂ is the candidate Y-axis coordinate of the candidate feature anchor point C₁₆₂, Y₃₄ is the candidate Y-axis coordinate of the candidate feature anchor point C₃₄, and Y₁₅₆ is the candidate Y-axis coordinate of the candidate feature anchor point C_{156.}

In an embodiment, the M candidate feature anchor point may include a first candidate feature anchor point and a second candidate feature anchor point. The first candidate feature anchor point corresponds to a first weight, and the second candidate feature anchor point corresponds to a second weight. A distance between the first candidate feature anchor point and the feature anchor point to be replaced is a first distance, and a distance between the second candidate feature anchor point and the feature anchor point to be replaced is a second distance. The first weight may be associated with the first distance and the second distance, and the second weight may be associated with the first distance and the second distance. The description will be continued below.

FIG. 4 is a schematic diagram of weights and distances of candidate feature anchor points according to an embodiment of the disclosure. With reference to FIG. 1 and FIG. 4 together, as shown in FIG. 4, it is assumed that the processor 130 selects the candidate feature anchor point C₁₂₇, the candidate feature anchor point C₃₄, the candidate feature anchor point C₁₃₉, and the candidate feature anchor point C₁₆₂ from the 468 candidate feature anchor points (i.e., M is 4 in this embodiment). In addition, it is assumed that that a distance between the candidate feature anchor point C₁₂₇ and the feature anchor point to be replaced P₀ is R₁₂₇, a distance between the candidate feature anchor point C₃₄ and the feature anchor point to be replaced P₀ is R₃₄, a distance between the candidate feature anchor point C₁₃₉ and the feature anchor point to be replaced P₀ is R₁₃₉, and a distance between the candidate feature anchor point C₁₆₂, and the feature anchor point to be replaced P₀ is R₁₆₂. When the processor 130 is to determine the updated feature anchor point corresponding to the feature anchor point to be replaced P₀, to calculate the updated coordinates of the updated feature anchor point, the processor 130 may first use Formulae 6 to 9 below to determine a weight W₁₂₇ of the candidate feature anchor point C₁₂₇, a weight W₁₃₉ of the candidate feature anchor point C₁₃₉, a weight W₁₆₂ of the candidate feature anchor point C₁₆₂, and a weight W₃₄ of the candidate feature anchor point C₃₄. In other words, the ratios of the weights of the four candidate feature anchor points to each other may be the reciprocals of the distances to the feature anchor point to be replaced P₀.

$${W}_{127} = \frac{\frac{1}{{R}_{127}}}{\frac{1}{{R}_{127}} + \frac{1}{{R}_{139}} + \frac{1}{{R}_{162}} + \frac{1}{{R}_{34}}} \qquad ( Formula 6 )$$

$${W}_{139} = \frac{\frac{1}{{R}_{139}}}{\frac{1}{{R}_{127}} + \frac{1}{{R}_{139}} + \frac{1}{{R}_{162}} + \frac{1}{{R}_{34}}} \qquad ( Formula 7 )$$

$${W}_{162} = \frac{\frac{1}{{R}_{162}}}{\frac{1}{{R}_{127}} + \frac{1}{{R}_{139}} + \frac{1}{{R}_{162}} + \frac{1}{{R}_{34}}} \qquad ( Formula 8 )$$

$${W}_{34} = \frac{\frac{1}{{R}_{34}}}{\frac{1}{{R}_{127}} + \frac{1}{{R}_{139}} + \frac{1}{{R}_{162}} + \frac{1}{{R}_{34}}} \qquad ( Formula 9 )$$

In other embodiments, the weight of the candidate feature anchor point may be a fixed value. For example, further to FIG. 4 and the embodiment thereof, the weight W₁₂₇ of the candidate feature anchor point C₁₂₇, the weight W₁₃₉ of the candidate feature anchor point C₁₃₉, the weight W₁₆₂ of the candidate feature anchor point C₁₆₂, and the weight W₃₄ of the candidate feature anchor point C₃₄ may respectively be 64%, 27%, 8%, and 1%, but the disclosure is not limited thereto.

In an embodiment, M may be 1. In other words, to calculate the updated coordinates of the updated feature anchor point, the processor 130 may select the (one) candidate feature anchor point at a “closest” distance to the feature anchor point to be replaced P₀ from the 468 candidate feature anchor points. Next, the processor 130 may use the weight and the candidate coordinates of this candidate feature anchor point to calculate the updated coordinates of the updated feature anchor point. Since there is one candidate feature anchor point at this time, the processor 130 may set the weight thereof to 100%. In other words, the processor 130 may directly take the candidate coordinates of the (one) candidate feature anchor point as the updated coordinates (of the updated feature anchor point).

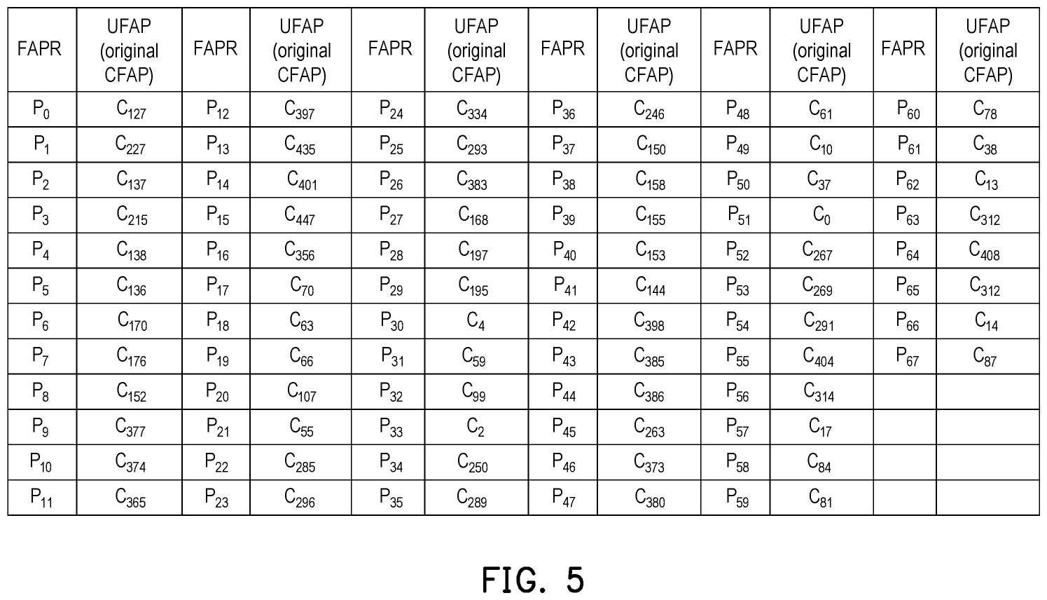

FIG. 5 is a schematic diagram of correspondence relationships between feature anchor points to be replaced and updated feature anchor points according to an embodiment of the disclosure. With reference to FIG. 1, FIG. 3, FIG. 4, and FIG. 5 together, in this embodiment, it is assumed that M is 1. In other words, as described in the embodiments above, for each feature anchor point to be replaced (referred to as FAPR in FIG. 5), the processor 130 may find out the (one) candidate feature anchor point (referred to as CFAP in FIG. 5) at a “closest” distance to this feature anchor point to be replaced, and directly take the candidate coordinates of the (one) candidate feature anchor point as the updated coordinates (of the updated feature anchor point (referred to as UFAP in FIG. 5)). For example, as shown in FIG. 5, for the feature anchor point to be replaced P₀, the processor 130 may directly use the candidate coordinates of the candidate feature anchor point C₁₂₇ at a closest distance to the feature anchor point to be replaced P₀ as the updated coordinates (of the updated feature anchor point). Similarly, for a feature anchor point to be replaced P₁, the processor 130 may directly use the candidate coordinates of a candidate feature anchor point C₂₂₇ at a closest distance to the feature anchor point to be replaced P₁ as the updated coordinates (of the updated feature anchor point). By analogy, the processor 130 may perform the same operation on each of the feature anchor points to be replaced to obtain the correspondence relationships as shown in FIG. 5.

With reference back to FIG. 2, in step S230, the processor 130 may perform an adjustment operation on a three-dimensional model to obtain an adjusted three-dimensional model.

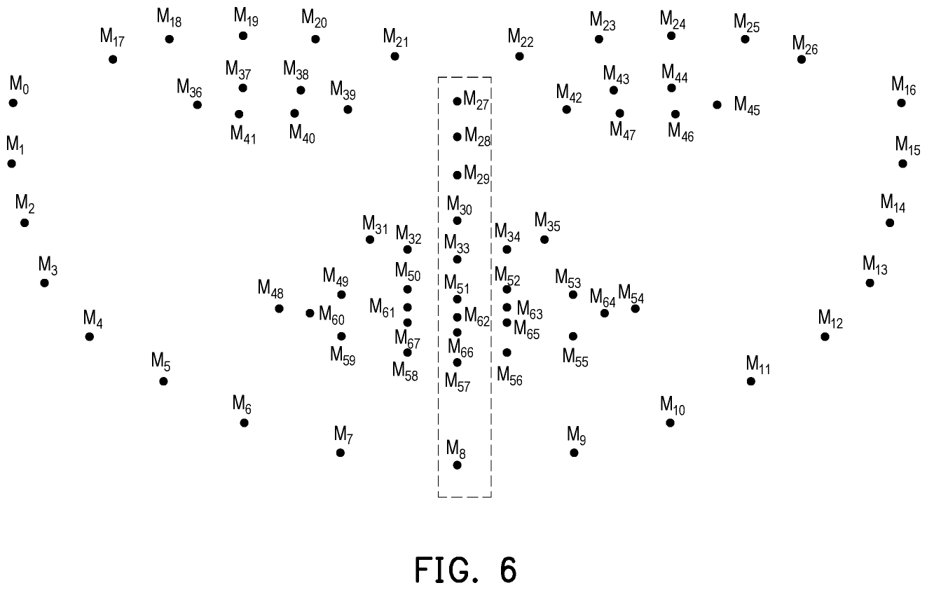

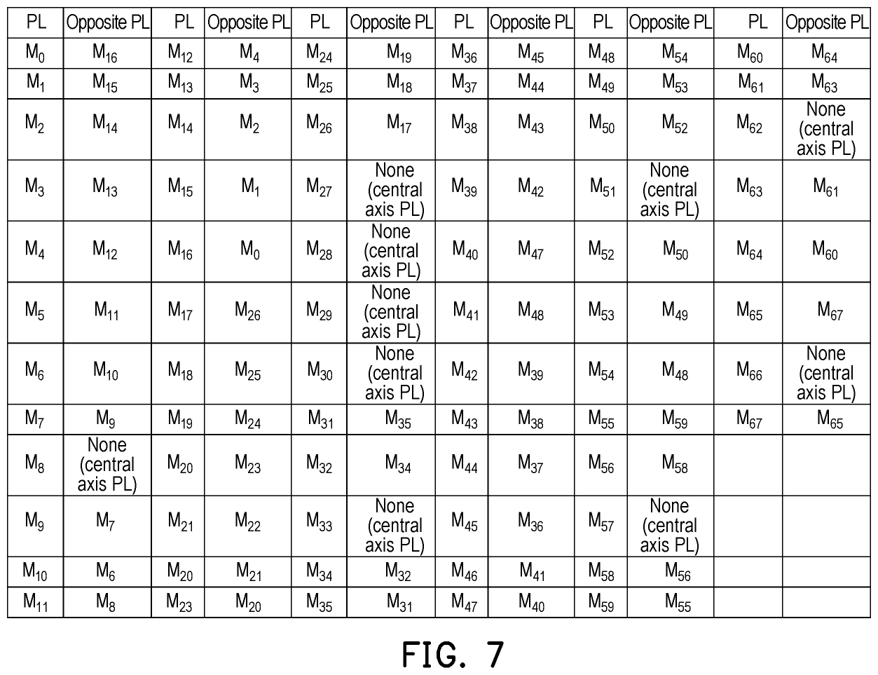

FIG. 6 is a schematic diagram of point locations in a three-dimensional model according to an embodiment of the disclosure. FIG. 7 is a schematic diagram of central axis point locations and opposite point locations relative to a central axis of the three-dimensional model of FIG. 6. With reference to FIG. 1, FIG. 6, and FIG. 7 together, in this embodiment, the three-dimensional model may include a plurality of point locations (referred to as PL in FIG. 7). Specifically, as shown in FIG. 6, the three-dimensional model of a human face may include 68 point locations, for example, a point location M₀, a point location M₁, . . . , and a point location M₆₇. Further, the plurality of point locations may include a reference point location and a plurality of remaining point locations. The processor 130 may calculate coordinates of each of the plurality of remaining point locations according to reference coordinates of the reference point location. For example, the processor 130 may set the point location M₂₇ (i.e., a glabella of the human face) to be the reference point location, and translate coordinates of the point location M₂₇ to (0, 0, 0). Then, the processor 130 may respectively calculate X-axis coordinates, Y-axis coordinates, and Z-axis coordinates of the 67 remaining point locations according to Formula 10, Formula 11, and Formula 12.

X_{j_}after=X_{j_}before−X_{27_}before (Formula 10)

Yⱼ_after=Yⱼ_before−Y₂₇_before (Formula 11)

Zⱼ_after=Zⱼ_before−Z₂₇_before (Formula 12)

where X₂₇_before is the original X-axis coordinate of the point location M₂₇ before translated, Y₂₇_before is the original Y-axis coordinate of the point location M₂₇ before translated, and Z₂₇_before is the original Z-axis coordinate of the point location M₂₇ before translated; Xⱼ_before is the original X-axis coordinate of each point location except the point location M₂₇ among the 68 point locations, Xⱼ_after is the updated X-axis coordinate of each point location except the point location M₂₇ among the 68 point locations, Yⱼ_before is the original Y-axis coordinate of each point location except the point location M₂₇ among the 68 point locations, Yⱼ_after is the updated Y-axis coordinate of each point location except the point location M₂₇ among the 68 point locations, Zⱼ_before is the original Z-axis coordinate of each point location except the point location M₂₇ among the 68 point locations, and Zⱼ_after is the updated Z-axis coordinate of each point location except the point location M₂₇ among the 68 point locations; the value of j ranges from 0, 1, 2, . . . , to 26, 28, 29, . . . , to 67 (i.e., j is not 27).

In an embodiment, the plurality of point locations may include a central axis point location and a non-central axis point location. The processor 130 may set an updated X-axis coordinate of the central axis point location to 0. For example, as shown in FIG. 6 and FIG. 7, the central axis point location may include the point location M₈, the point location M₂₇, the point location M₂₈, the point location M₂₉, the point location M₃₀, the point location M₃₃, the point location M₅₁, the point location M₅₇, the point location M₆₂, and the point location M₆₆. The processor 130 may set the updated X-axis coordinate of the central axis point location to 0 according to Formula 13. In other words, the Y-axis coordinate and the Z-axis coordinate of the central axis point location may remain unchanged.

X₈_after=X₂₇_after=X₂₈_after=X₂₉_after=X₃₀_after=X₃₃_after =X₅₁_after=X_{57_}after=X₆₂_after=X₆₆_after=0 (Formula 13)

where X₈_after is the updated X-axis coordinate of the point location M₈, X₂₇_after is the updated X-axis coordinate of the point location M₂₇, X₂₈_after is the updated X-axis coordinate of the point location M₂₈, X₂₉_after is the updated X-axis coordinate of the point location M₂₉, X₃₀_after is the updated X-axis coordinate of the point location M₃₀, X₃₃_after is the updated X-axis coordinate of the point location M₃₃, X₅₁_after is the updated X-axis coordinate of the point location M₅₁, X₅₇_after is the updated X-axis coordinate of the point location M₅₇, X₆₂_after is the updated X-axis coordinate of the point location M₆₂, and X₆₆_after is the updated X-axis coordinate of the point location M₆₆.

Further, the non-central axis point location may include a first point location and a second point location, and the first point location and the second point location are relative to the central axis of the three-dimensional model. The processor 130 may use original coordinates of the first point location and original coordinates of the second point location to calculate update coordinates of the first point location and calculate update coordinates of the second point location. Specifically, as shown in FIG. 6 and FIG. 7, the point location M₀ and the point location M₁₆ among the non-central axis point locations are relative to the central axis of the three-dimensional model. The processor 130 may use original coordinates of the point location M₀ and original coordinates of the point location M₁₆ to calculate update coordinates of the point location M₀, and may use the original coordinates of the point location M₀ and the original coordinates of the point location M₁₆ to calculate update coordinates of the point location M₁₆. For example, the processor 130 may use Formula 14 to calculate an updated Y-axis coordinate of the point location M₀ and an updated Y-axis coordinate of the point location M₁₆. Then, the processor 130 may use Formula 15 to calculate an updated Z-axis coordinate of the point location M₀ and an updated Z-axis coordinate of the point location M₁₆.

$${Y}_{0} \_after = {Y}_{16} \_after = \frac{{Y}_{0} \_before + {Y}_{16} \_before}{2} \qquad ( Formula 14 )$$

where Y₀_after is the updated Y-axis coordinate of the point location M₀, Y₁₆_after is the updated Y-axis coordinate of the point location M₁₆, Y₀_before is the original Y-axis coordinate of the point location M₀, and Y₁₆_before is the original Y-axis coordinate of the point location M₁₆.

$${Z}_{0} \_after = {Z}_{16} \_after = \frac{{Z}_{0} \_before + {Z}_{16} \_before}{2} \qquad ( Formula 15 )$$

where Z₀_after is the updated Z-axis coordinate of the point location M₀, Z₁₆_after is the updated Z-axis coordinate of the point location M₁₆, Z₀_before is the original Z-axis coordinate of the point location M₀, and Z₁₆_before is the original Z-axis coordinate of the point location M₁₆.

Next, the processor 130 may use Formula 16 and Formula 17 to calculate the updated X-axis coordinate of the point location M₀ and the updated X-axis coordinate of the point location M₁₆. In other words, the sum of the updated X-axis coordinate of the point location M₀ and the updated X-axis coordinate of the point location M₁₆ is 0.

$${X}_{0} \_after = \frac{{X}_{0} \_before - {X}_{16} \_before}{2} \qquad ( Formula 16 )$$

$${X}_{16} \_after = \frac{{X}_{16} \_before - {X}_{0} \_before}{2} \qquad ( Formula 17 )$$

where X₀_after is the updated X-axis coordinate of the point location M₀, X₁₆_after is the updated X-axis coordinate of the point location M₁₆, X₀_before is the original X-axis coordinate of the point location M₀, and X₁₆_before is the original X-axis coordinate of the point location M₁₆.

After the adjustment operation of Formulae 10 to 17 above is performed on each point location in the three-dimensional model as shown in FIG. 6, the adjusted three-dimensional model may be symmetrical in the left-right direction.

With reference back to FIG. 2, in step S240, the processor 130 may use the updated feature anchor point and the adjusted three-dimensional model to calculate a swinging direction of the human face. Specifically, the processor 130 may use the updated feature anchor point determined in step S220 (e.g., the 68 updated feature anchor points shown in FIG. 5) and the adjusted three-dimensional model obtained in step S230 (e.g., including 68 point locations) to perform three-dimensional posture calculation. The three-dimensional posture calculation includes solvePnP technology, for example but the disclosure is not limited thereto. Next, the processor 130 may use rotation vector technology, conversion technology of rotation vector and rotation matrix (e.g., Rodrigues technology), rotation matrix technology, and inverse trigonometric function technology to calculate the swinging direction of the human face, but the disclosure is not limited thereto.

In an embodiment, the updated feature anchor point may correspond to a glabella of the human face. The processor 130 may translate the updated feature anchor point to a central position in the obscured human face image. The description will be continued below.

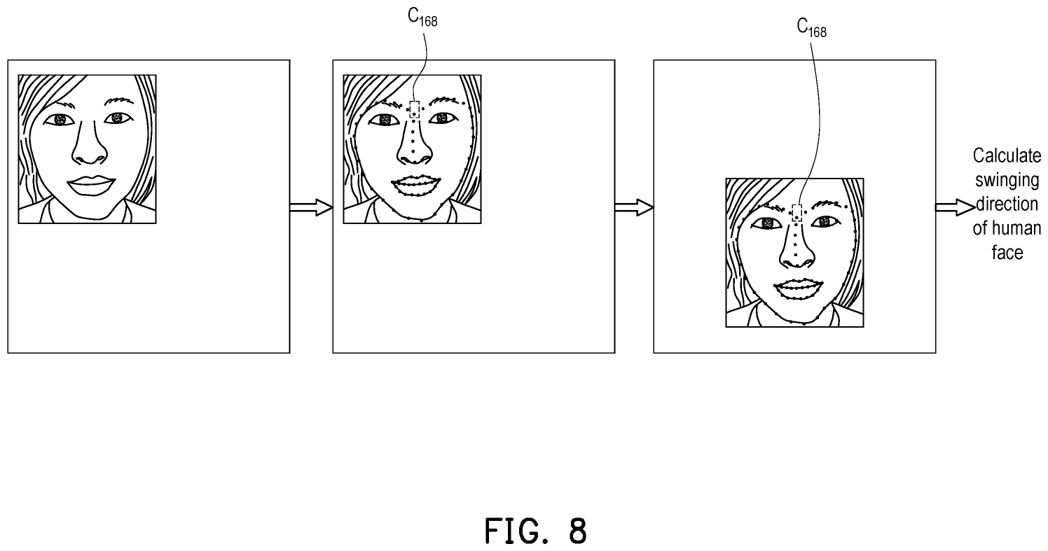

FIG. 8 is a schematic diagram of translating an updated feature anchor point to a central position in an obscured human face image according to an embodiment of the disclosure. With reference to FIG. 1, FIG. 5, and FIG. 8 together, it is assumed here that a feature anchor point to be replaced P₂₇ is a glabella of a human face. Since the processor 130 has determined an updated feature anchor point C₁₆₈ corresponding to the feature anchor point to be replaced P₂₇ in step S220 as described above, the processor 130 may translate the updated feature anchor point C₁₆₈ to the central position in the obscured human face image as shown in FIG. 8. Next, the processor 130 may translate the remaining 67 updated feature anchor points shown in FIG. 5 along with the updated feature anchor point C₁₆₈ to use the coordinates of the updated feature anchor points that are translated to calculate a swinging direction of the human face. On this basis, regardless of the position of the human face in the obscured human face image, the correct swinging direction of the human face could be calculated according to an embodiment of the disclosure.

In an embodiment, the swinging direction may include a first swinging direction at a first time point and may include a second swinging direction at a second time point. The processor 130 may use a moving average algorithm to display the first swinging direction and the second swinging direction through the output device 140.

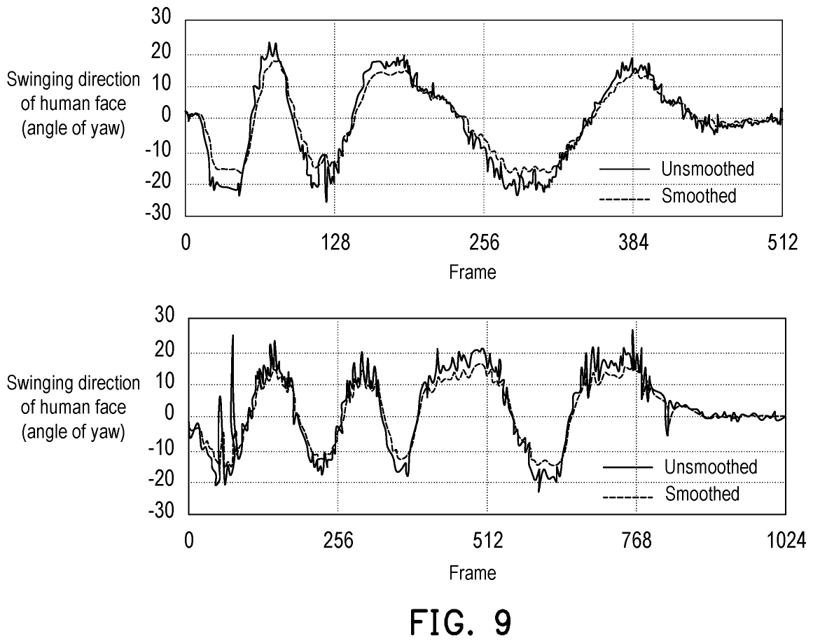

FIG. 9 is a schematic diagram of a swinging direction of a human face according to an embodiment of the disclosure. With reference to FIG. 1 and FIG. 9 together, yaw is taken as an example of the swinging direction of this embodiment, but the disclosure is not limited thereto. As shown in FIG. 9, for consecutive frames at different time points in the obscured human face image, after performing step S210 to step S240 shown in FIG. 2 on the consecutive frames, the processor 130 may use a moving average algorithm to display swinging directions at different time points through the output device 140. Accordingly, the displayed swinging directions could be smoothed.

In summary of the foregoing, according to the embodiment of the disclosure, in the device and the method for calculating a swinging direction of a human face in an obscured human face image, non-obscured face detection technology may first be used on the obscured human face image to obtain the feature anchor point to be replaced. Then, obscured face detection technology may be used to obtain the plurality of candidate feature anchor points. In addition, the plurality of candidate feature anchor points may be used to determine the updated feature anchor point corresponding to the feature anchor point to be replaced. In this way, the updated feature anchor point and the three-dimensional model may be used to calculate a swinging direction of the human face. Further, according to the embodiment of the disclosure, in the device and the method for calculating a swinging direction of a human face in an obscured human face image, the adjustment operation may also be performed on the three-dimensional model to make the three-dimensional model be symmetrical in the left-right direction, so that the swinging direction of the obscured human face could be correctly calculated.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A device for calculating a swinging direction of a human face in an obscured human face image, the device comprising:
an image capturing device;
a storage medium storing a three-dimensional model; and
a processor coupled to the image capturing device and the storage medium, wherein the processor is configured to:
capture an obscured human face image comprising a human face through the image capturing device;
use non-obscured face detection technology to obtain a feature anchor point to be replaced in the obscured human face image, use obscured face detection technology to obtain a plurality of candidate feature anchor points in the obscured human face image, and use the plurality of candidate feature anchor points to determine an updated feature anchor point corresponding to the feature anchor point to be replaced;
perform an adjustment operation on a three-dimensional model to obtain an adjusted three-dimensional model; and
use the updated feature anchor point and the adjusted three-dimensional model to calculate a swinging direction of the human face.

2. The device according to claim 1, wherein each of the plurality of candidate feature anchor points corresponds to a weight, and each of the plurality of candidate feature anchor points corresponds to candidate coordinates, wherein the processor is further configured to:
use the weight and the candidate coordinates to calculate updated coordinates of the updated feature anchor point.

3. The device according to claim 2, wherein the processor is further configured to:
obtain M candidate feature anchor points from the plurality of candidate feature anchor points, wherein a distance between each of the M candidate feature anchor points and the feature anchor point to be replaced is less than a distance threshold; and
use the weight and the candidate coordinates of each of the M candidate feature anchor points to calculate the updated coordinates, where M is a non-zero natural number.

4. The device according to claim 3, wherein the M candidate feature anchor points comprise a first candidate feature anchor point and a second candidate feature anchor point, wherein the first candidate feature anchor point corresponds to a first weight, and the second candidate feature anchor point corresponds to a second weight, wherein a distance between the first candidate feature anchor point and the feature anchor point to be replaced is a first distance, and a distance between the second candidate feature anchor point and the feature anchor point to be replaced is a second distance, wherein the first weight is associated with the first distance and the second distance, and the second weight is associated with the first distance and the second distance.

5. The device according to claim 3, wherein M is 1.

6. The device according to claim 1, wherein the three-dimensional model comprises a plurality of point locations, and the plurality of point locations comprise a reference point location and a plurality of remaining point locations, wherein the processor is further configured to:
compute coordinates of each of the plurality of remaining point locations according to reference coordinates of the reference point location.

7. The device according to claim 6, wherein the plurality of point locations comprise a central axis point location and a non-central axis point location, wherein the non-central axis point location comprises a first point location and a second point location, and the first point location and the second point location are relative to a central axis of the three-dimensional model, wherein the processor is further configured to:
set an updated X-axis coordinate of the central axis point location to 0; and
use original coordinates of the first point location and original coordinates of the second point location to calculate update coordinates of the first point location and calculate update coordinates of the second point location.

8. The device according to claim 1, wherein the updated feature anchor point corresponds to a glabella of the human face, wherein the processor is further configured to:
translate the updated feature anchor point to a central position in the obscured human face image.

9. The device according to claim 1, further comprising an output device coupled to the processor, wherein the swinging direction comprises a first swinging direction at a first time point and comprises a second swinging direction at a second time point, wherein the processor is further configured to:
use a moving average algorithm to display the first swinging direction and the second swinging direction through the output device.

10. The device according to claim 1, wherein the obscured human face image comprises a color image or an infrared image.

11. A method for calculating a swinging direction of a human face in an obscured human face image, the method comprising:
capturing an obscured human face image comprising a human face;
using non-obscured face detection technology to obtain a feature anchor point to be replaced in the obscured human face image, using obscured face detection technology to obtain a plurality of candidate feature anchor points in the obscured human face image, and using the plurality of candidate feature anchor points to determine an updated feature anchor point corresponding to the feature anchor point to be replaced;
performing an adjustment operation on a three-dimensional model to obtain an adjusted three-dimensional model; and
using the updated feature anchor point and the adjusted three-dimensional model to calculate a swinging direction of the human face.

12. The method according to claim 11, wherein each of the plurality of candidate feature anchor points corresponds to a weight, and each of the plurality of candidate feature anchor points corresponds to candidate coordinates, wherein using the plurality of candidate feature anchor points to determine the updated feature anchor point corresponding to the feature anchor point to be replaced comprises:
using the weight and the candidate coordinates to calculate updated coordinates of the updated feature anchor point.

13. The method according to claim 12, wherein using the weight and the candidate coordinates to calculate the updated coordinates of the updated feature anchor point comprises:
obtaining M candidate feature anchor points from the plurality of candidate feature anchor points, wherein a distance between each of the M candidate feature anchor points and the feature anchor point to be replaced is less than a distance threshold; and
using the weight and the candidate coordinates of each of the M candidate feature anchor points to calculate the updated coordinates, where M is a non-zero natural number.

14. The method according to claim 13, wherein the M candidate feature anchor points comprise a first candidate feature anchor point and a second candidate feature anchor point, wherein the first candidate feature anchor point corresponds to a first weight, and the second candidate feature anchor point corresponds to a second weight, wherein a distance between the first candidate feature anchor point and the feature anchor point to be replaced is a first distance, and a distance between the second candidate feature anchor point and the feature anchor point to be replaced is a second distance, wherein the first weight is associated with the first distance and the second distance, and the second weight is associated with the first distance and the second distance.

15. The method according to claim 13, wherein M is 1.

16. The method according to claim 11, wherein the three-dimensional model comprises a plurality of point locations, and the plurality of point locations comprise a reference point location and a plurality of remaining point locations, wherein performing the adjustment operation on the three-dimensional model to obtain the adjusted three-dimensional model comprises:
computing coordinates of each of the plurality of remaining point locations according to reference coordinates of the reference point location.

17. The method according to claim 16, wherein the plurality of point locations comprise a central axis point location and a non-central axis point location, wherein the non-central axis point location comprises a first point location and a second point location, and the first point location and the second point location are relative to a central axis of the three-dimensional model, wherein performing the adjustment operation on the three-dimensional model to obtain the adjusted three-dimensional model further comprises:
setting an updated X-axis coordinate of the central axis point location to 0; and
using original coordinates of the first point location and original coordinates of the second point location to calculate update coordinates of the first point location and calculate update coordinates of the second point location.

18. The method according to claim 11, wherein the updated feature anchor point corresponds to a glabella of the human face, wherein using the updated feature anchor point and the adjusted three-dimensional model to calculate the swinging direction of the human face comprises:
translating the updated feature anchor point to a central position in the obscured human face image.

19. The method according to claim 11, wherein the swinging direction comprises a first swinging direction at a first time point and comprises a second swinging direction at a second time point, wherein the method further comprises:
using a moving average algorithm to display the first swinging direction and the second swinging direction.

20. The method according to claim 11, wherein the obscured human face image comprises a color image or an infrared image.
